(19) United States
(12) Patent Application Publication
(10) Pub. No.: US 2004/0131416 A1
(43) Pub. Date: Jul. 8, 2004

(54) KD furniture adapter

(76) Inventors: Hang-Chi Wu, Changhua City (TW); Yi-Yi Liang, Changhua Hsien (TW); Kuan-Chieh Yu, Changhua Hsien (TW)

Correspondence Address: RABIN & BERDO, P.C., SUITE 500, 1101 14 th STREET, N.W., WASHINGTON, DC, 20005, US

(21) Appl. No.: 10/335,953

(22) Filed: Jan. 3, 2003

(51) Int. Cl. F16L 41/00

(52) U.S. Cl. 403/170

(57) ABSTRACT

An adapter with improved connection function applicable to connection of KD furniture including cabinet, chest or rack, comprised with four 90-degree angular grooves, a cross clamping structure protruding from one side of the adapter, a hole in the center of the clamping structure, the clamping structure including two parallel clamping boards, multiple slip stoppers provided at equal spacing on the inner side of each clamping board, and an insertion structure provided externally to the clamping structure, a deeper hole provided to the insertion structure to connect to more parts, e.g. a door panel, cabinet, chest or a rack frame.

### BACKGROUND OF THE INVENTION

(a) Field of the Invention

The present invention is related to an adapter, and more particularly, to one that is used for KD furniture or rack to connect among parts.

(b) Description of the Prior Art

FIG. 1 of the accompanying drawings of the present invention shows an adapter 1 of the prior art and FIG. 2, a box comprised of multiple sheets of glass and adapters of the prior art. The adapter 1 is comprised of four angular troughs 2 inside the main portion of the adapter 1 with each indicating a right angle; on one side of the adapter 1 is protruded two clamping board 3 crossing each other; a hole 4 is provided at the intersection of both clamping member 3; each clamping member 3 includes two clamping boards in parallel; and multiple slip stoppers 6 are protruding at equal spacing from the inner side of each board of the clamping member 3. However, the function of the adapter 1 is very limited, since the adapter 1 is available for the combination of only one box using two clamping boards to hold a panel or a sheet of glass 7, and it fails to be provided for the combination of other structures such as a door panel or a frame.

### SUMMARY OF THE INVENTION

The primary purpose of the present invention is to provide an adapter with additional insertion structure to the adapter of the prior art. To achieve the purpose, each additional insertion structure is graded and a deeper hole is provided axially on the gradation for the deeper hole to connect to more parts as the case of a door panel or a frame requires.

### BRIEF DESCRIPTION OF THE DRAWINGS

FIG. 1 is a perspective view of an adapter of the prior art.

FIG. 2 is a perspective view of a box comprised of the adapter of the prior art and multiple sheets of glass.

FIG. 3 is a perspective view of a first preferred embodiment of the present invention.

FIG. 4 is a sectional view taken from A-A cross section of the first preferred embodiment of the present invention.

FIG. 5 is a perspective view of a clamping structure of the first preferred embodiment of the present invention.

FIG. 6 is a perspective view of a second preferred embodiment of the present invention.

FIG. 7 is a cross sectional view of the second preferred embodiment of the present invention.

FIG. 8 is a perspective view of a third preferred embodiment of the present invention.

FIG. 9 is a cross sectional view of the third preferred embodiment of the present invention.

FIG. 10 is a view showing the first preferred embodiment combined with KD furniture.

FIG. 11 is an exploded view of the present invention and sheet of glass.

FIG. 12 is a local view showing an assembly of the present invention, multiple sheets of glass and a door panel.

FIG. 13 is a view showing the second preferred embodiment of the present invention combined with KD furniture.

FIG. 14 is an exploded view of the second preferred embodiment of the present invention combined with a KD furniture rack.

FIG. 15 is a local view showing an assembly of the present invention, multiple sheets of glass and a frame.

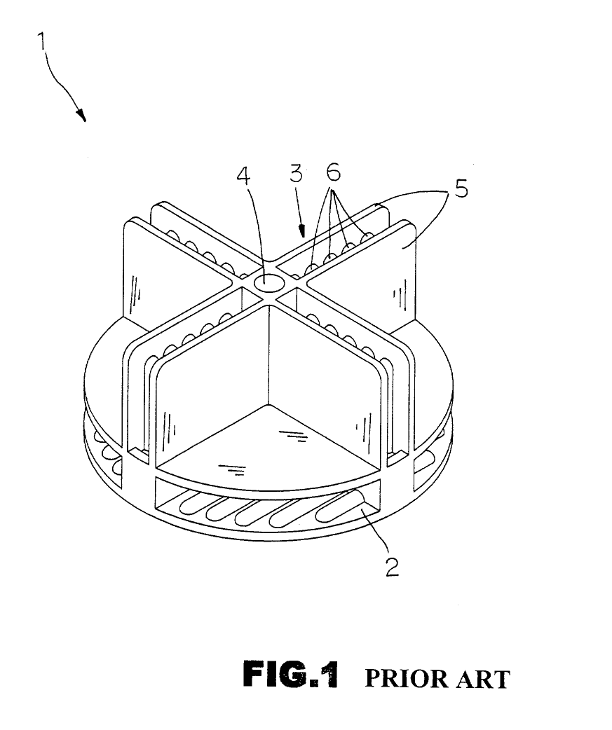

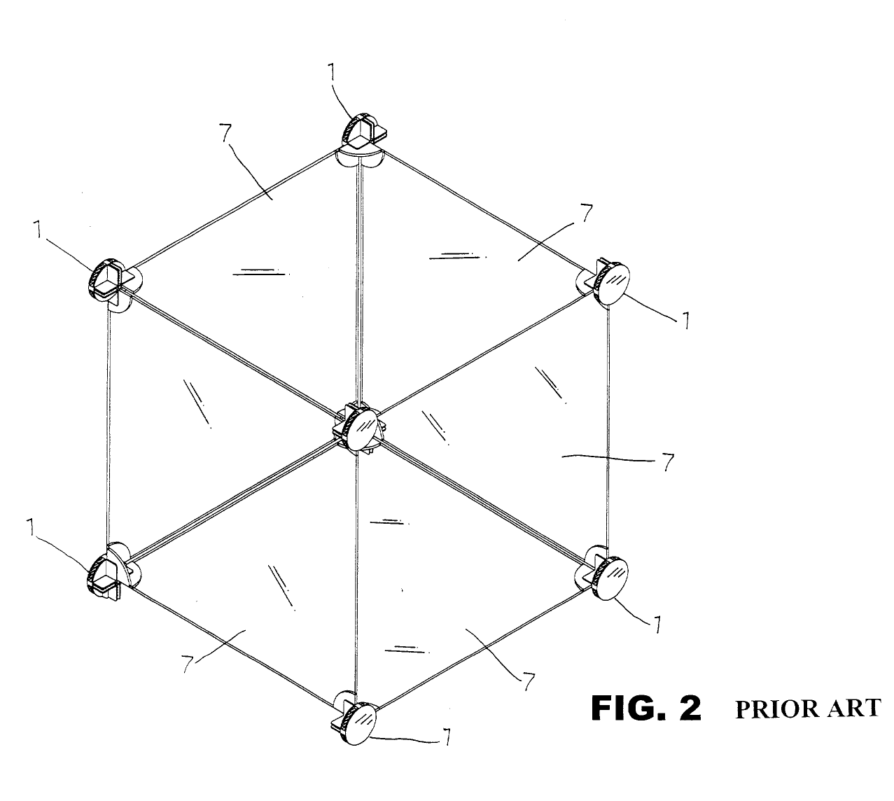

### DETAILED DESCRIPTION OF THE PREFERRED EMBODIMENTS

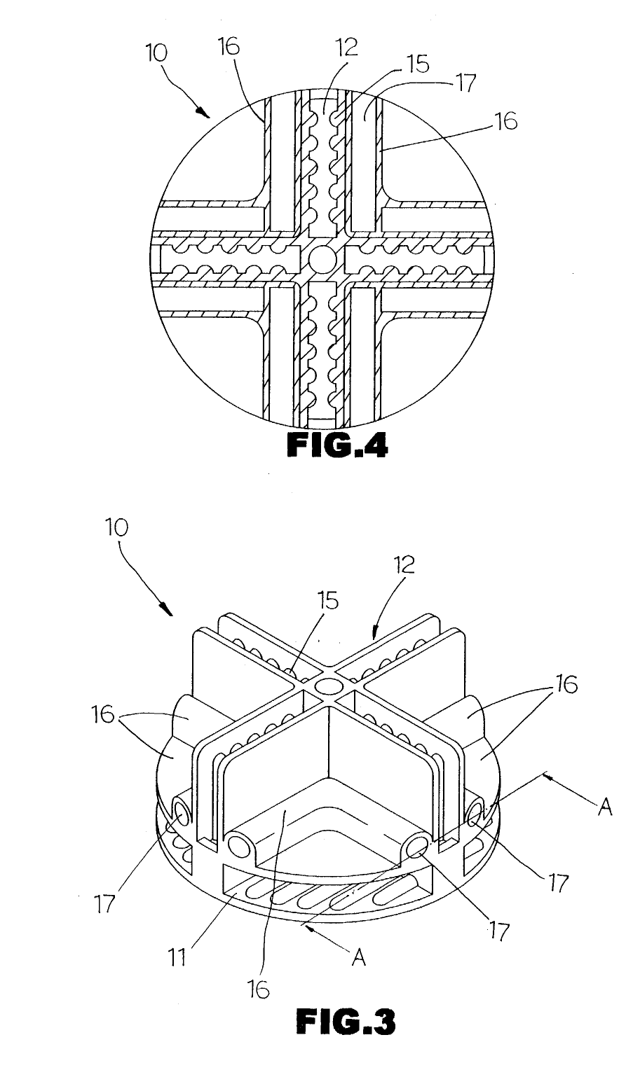

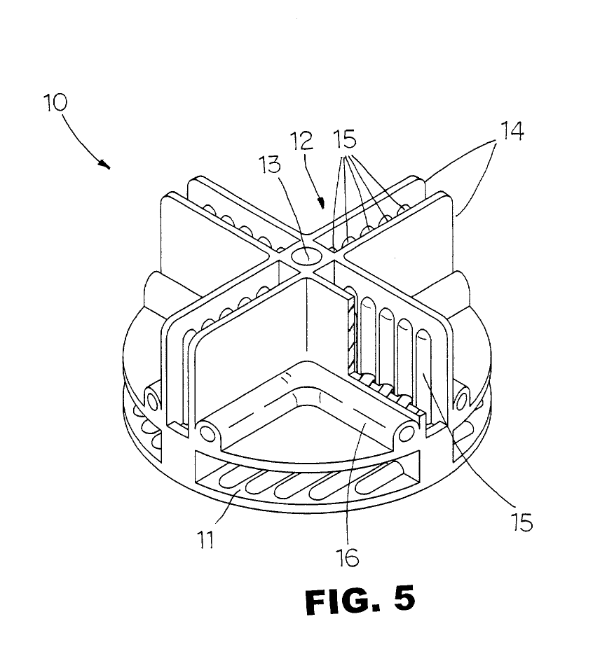

Referring to FIGS. 3, 4 and 5, an adapter of the first preferred embodiment of the present invention is made of plastic materials formed by an injection model in conjunction with dies. Four 90-degree angular grooves 11 are provided in the body of the adapter 1. A cross clamping structure 12 comprised of two clamping boards 14 in parallel rises from the top of the body of the adapter 1 and a hole 13 is provided at the center of the clamping structure 12. Multiple slip-proof stubs 15 arranged at equal spacing or variable spacing protrude between inner walls of both clamping boards 14 to help secure an inserted panel 20 (e.g., a wooden board, glass or plastic board). An insertion structure 16 is provided along the base of two halves of a butted external wall of the clamping board 14. The insertion structure 12 is provided with a gradation 16 and a deeper hole 17 is provided axially to the gradation. The hole 17 related to a bore and the gradation is not necessarily graded as long as it is sufficient to accommodate the deeper hole 17. The diameter of the deeper hole 17 is in proportion with the size of an object to be connected. The gradation of the insertion structure helps improve the strength of the clamping structure 12.

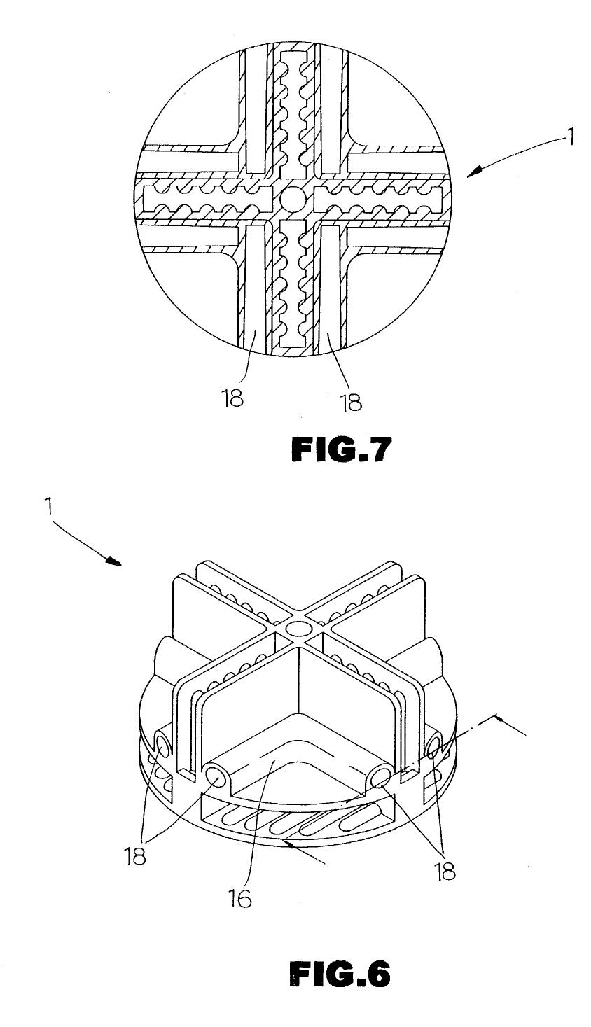

As illustrated in FIGS. 6 and 7 showing a second preferred embodiment of the present invention, wherein, a deeper hole of the insertion structure 16 of the adapter 10 relates to a tapered hole 18 to facilitate connection to a conic object while the deeper the connection is, the tighter the connection gets.

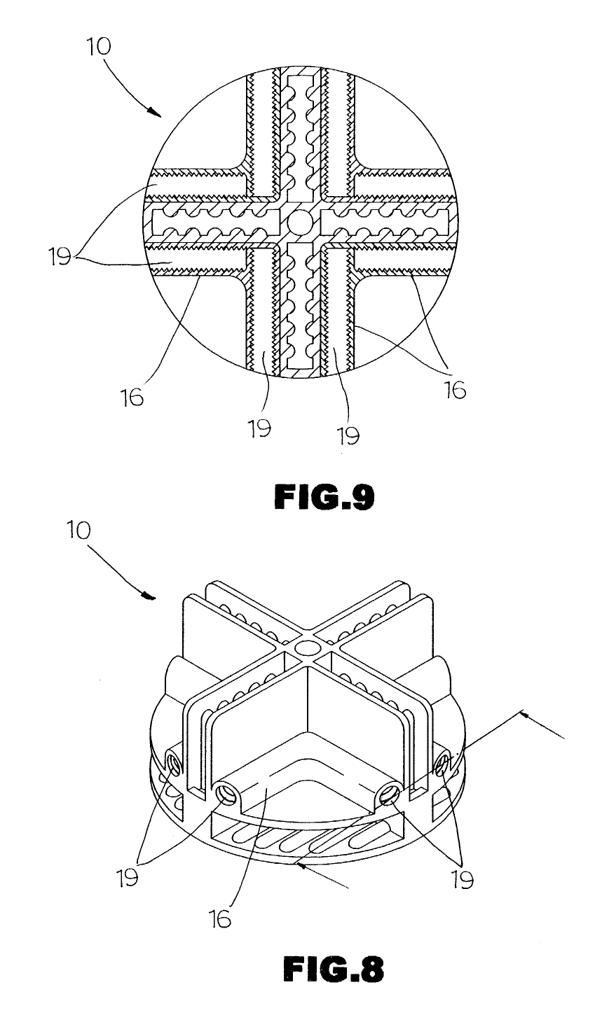

FIGS. 8 and 9 showing a third preferred embodiment of the present invention, wherein, a deeper hole of the insertion structure 16 of the adapter 10 relates to a threaded hole 19 to facilitate connection to an object with a threaded end.

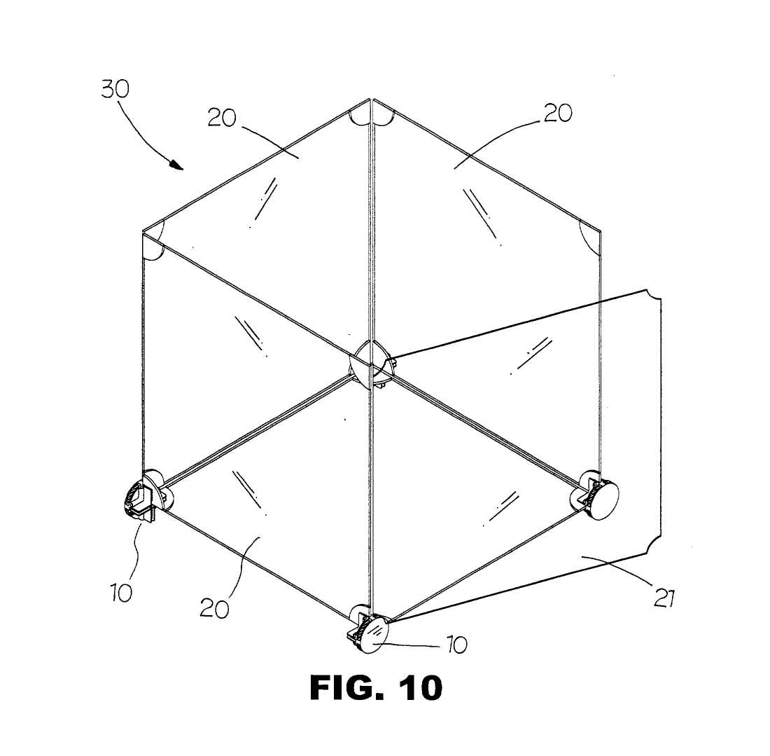

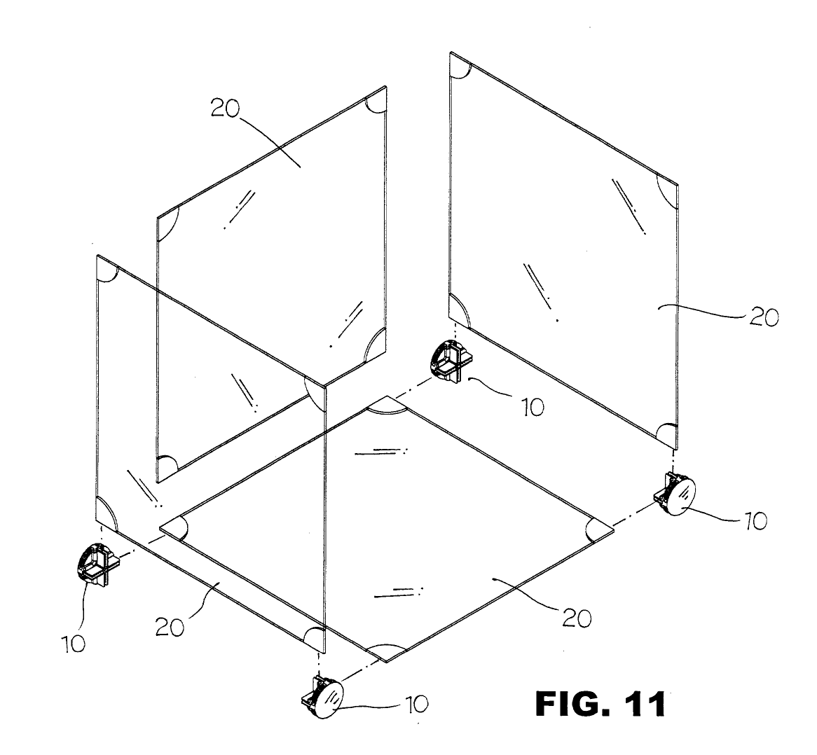

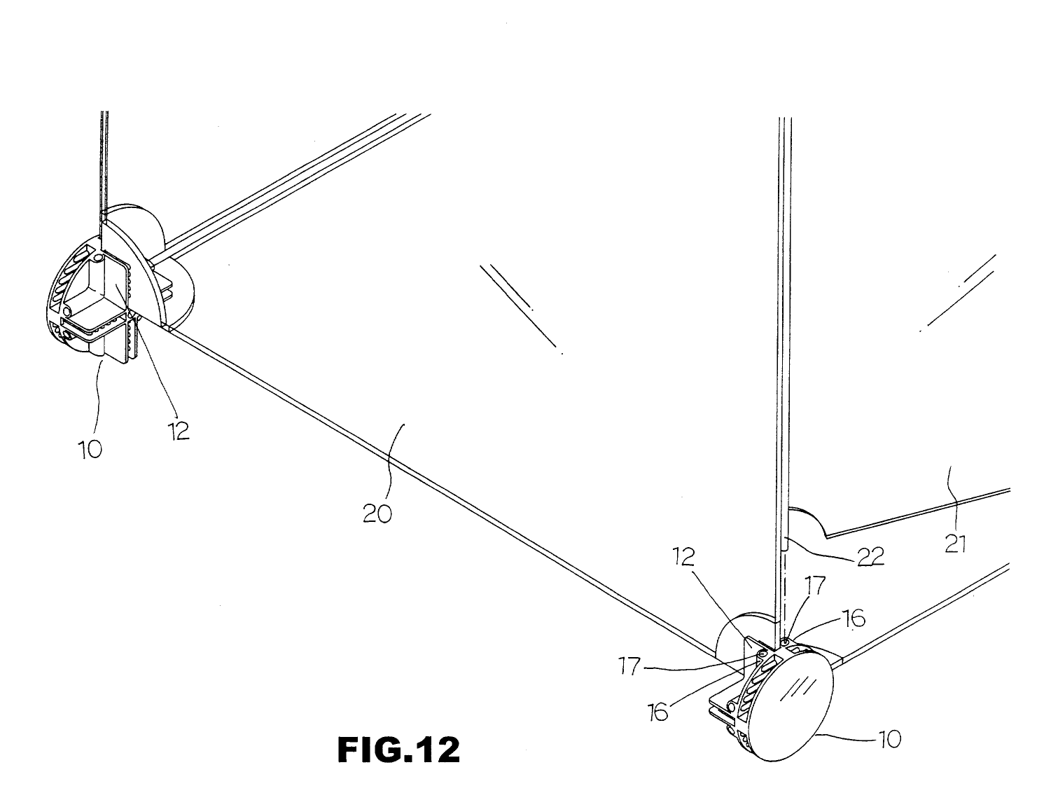

Now referring to FIGS. 10, 11 and 12 showing the first preferred embodiment of the present invention is connected to multiple sheets of glass 20, wherein, four corners of each of five sheets of glass are respectively inserted into the clamping structure 12 of eight adapters 10. Each sheet of glass 20 is secured by the slip-proof stubs 15 to form a box 30 with an opening. Another sheet of glass serving as a door panel 21 is then having the end of its side post to be inserted into the deeper hole 17 of the insertion structure, and a box with a door panel 21 can be fast and easy connected.

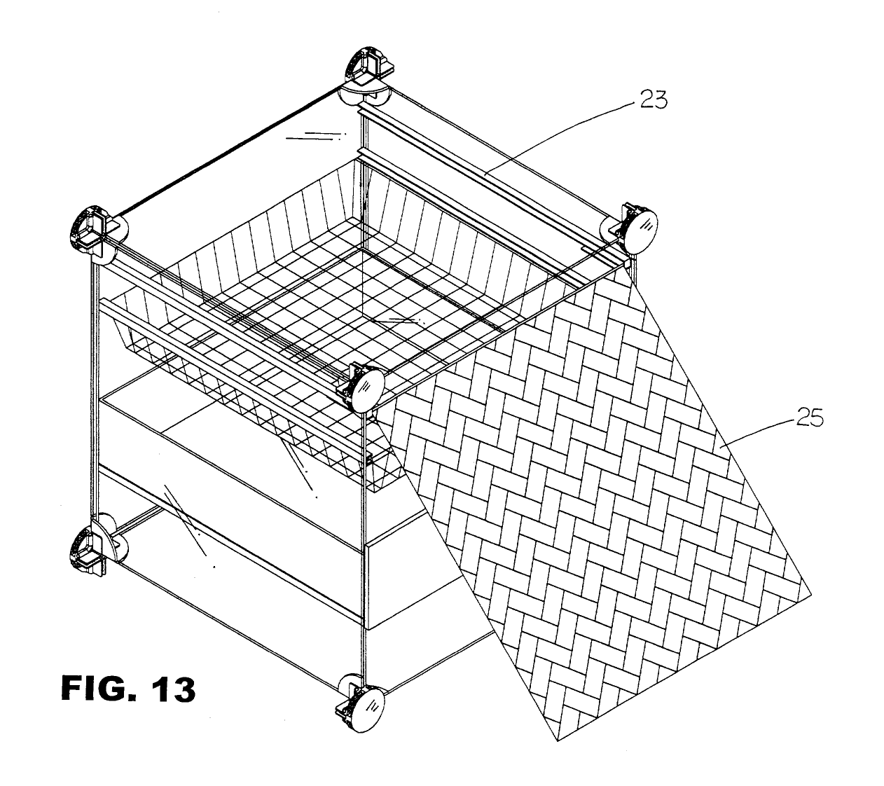

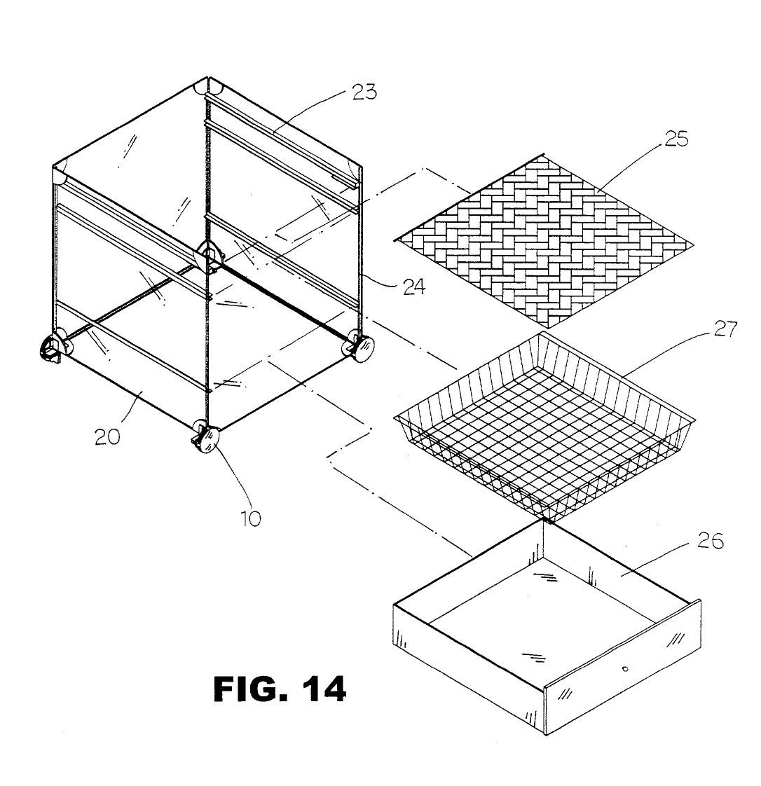

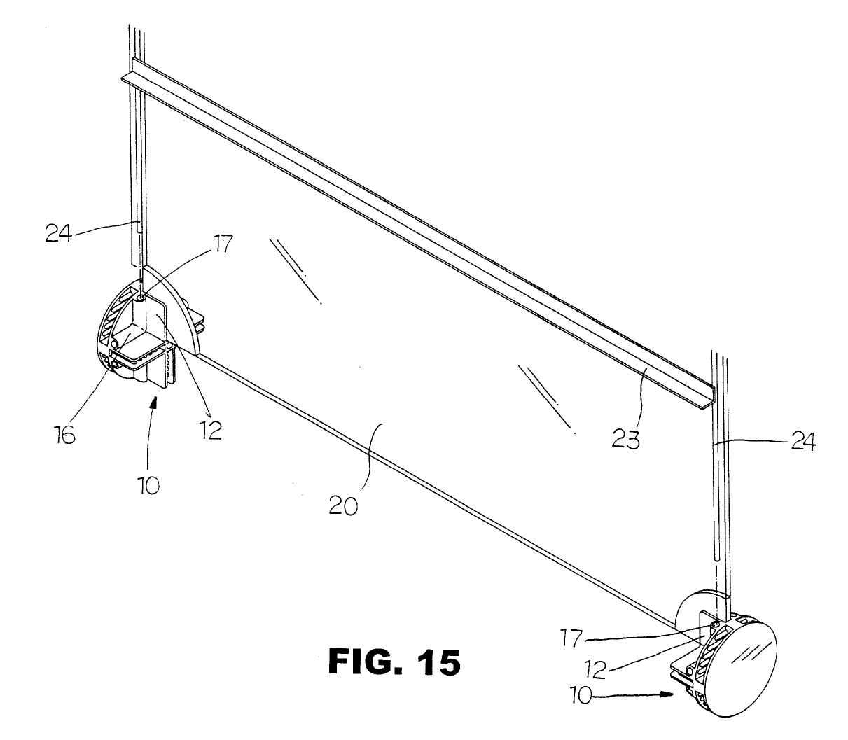

FIGS. 13, 14 and 15 shows the second preferred embodiment of the present invention is connected to multiple sheets of glass and a frame. Again, eight adapters 10 are used to respectively have four corners of each sheet of glass 20 inserted into the clamping structure 12 of the adapter 10. The sheet inserted can be of a wooden or plastic board. Each sheet of glass 20 is then firmly secured by those multiple slip-proof stubs 15. Then the end of a post from a frame 24 provided with multiple rows of tracks is inserted into the deeper hole 17 of the insertion structure while those multiple tracks can be further connected to a door panel 21, a drawer 26 or a mesh basket 27 to form a multi-purpose furniture combination rack.

The present invention by providing an additional insertion structure to improve the structure strength and provide more diversified applications is innovative. It is should be noted that any preferred embodiment given is for illustration purpose and by no means to limit the application scope of the prevent invention and any equivalent variation and modification made within the teaching of the present invention shall fall within the scope of what is to be claimed in the present invention.

1. An adapter is characterized by having provided an insertion structure externally to a clamping structure of the adapter and a deeper hole is provided to the insertion structure.

2. An adapter as claimed in claim 1, wherein, the insertion structure is provided with a gradation and the deeper hole is provided axially to the gradation.

3. An adapter as claimed in claim 1, wherein, the deeper hole to the insertion structure relates to a straight bore, threaded hole or a tapered hole.

4. An adapter as claimed in claim 1, wherein, the deeper hole to the insertion structure is provided to connect to a door panel or a frame.
